(19) United States
(12) Patent Application Publication
(10) Pub. No.: US 2020/0238561 A1
(43) Pub. Date: Jul. 30, 2020

(54) KERF FORMING APPARATUS AND METHOD

(71) Applicant: FRP PRODUCTIVITY INC., Edmonton (CA)

(72) Inventor: Roland MAJEAU, Edmonton (CA)

(21) Appl. No.: 16/747,369

(22) Filed: Jan. 20, 2020

Related U.S. Application Data
(60) Provisional application No. 62/798,818, filed on Jan. 30, 2019.

(51) Int. Cl. B27B 5/29; B27B 27/02; B23D 59/00

(52) U.S. Cl. CPC B27B 5/29; B23D 59/006; B27B 27/02

(57) ABSTRACT

An apparatus and method are provided for forming a kerf in a workpiece, which may be used with a table saw for simultaneously cutting the workpiece to length. A fence-engaging member engages a fence of the table saw to prevent movement of the apparatus relative to the fence. A rotary cutting tool for forming the kerf in the workpiece, is disposed above a work surface supporting the workpiece. A guide member for engaging the workpiece prevents the workpiece from translating in the transverse direction, while permitting the workpiece to translate on the longitudinal direction, on the work surface relative to the rotary cutting tool. A motor-actuated feed roller assists with moving the workpiece into engagement with the rotary cutting tool. An enclosure for the rotary cutting tool defines a dust collection port.

### FIELD OF THE INVENTION

The present invention relates generally to power tools, and more particularly to kerf forming apparatuses and methods. The apparatuses may be used as an accessory to a table saw to form a kerf in a workpiece, while the table saw simultaneously cuts the workpiece to length. Alternatively, the apparatuses may be used by themselves to from a kerf in a workpiece.

### BACKGROUND OF THE INVENTION

In light gauge steel stud wall construction, plywood backing spans between adjacent studs to provide support for heavy items (e.g., cabinets) that may be later attached to the wall. A typical steel stud has a C-shaped cross-section, with a short lip at the end of each of the flanges. A kerf—i.e., an elongate, linear groove or slot—is formed in the plywood backing to accept the lip. This helps to prevent the stud from twisting and bowing outwards when heavy items are attached to the wall. It also allows the plywood and face of stud to be flat. Without the kerf, the stud would deform when the screws are fastened through the stud to the backing.

Conventionally, the plywood backing is produced in a two-step process. First, a table saw is used to cut a plywood sheet to the length of the plywood backing between the studs. Second, a table saw, a portable circular saw, or a router, is subsequently used to form the kerf in the plywood backing. Even a wall of moderate size may require the production of hundreds of pieces of plywood backing. It would save time if the kerfs could be formed at the same time that the plywood sheets are cut to length.

### SUMMARY OF THE INVENTION

In one aspect, the present invention comprises an apparatus for forming a kerf in a workpiece along a longitudinal direction, in use with a saw for simultaneously cutting the workpiece to length in a transverse direction perpendicular to the longitudinal direction. The saw may be a table saw which comprises a work surface for supporting the workpiece, a saw blade for cutting the workpiece in the longitudinal direction, and a fence having a selectively fixable position in the transverse direction relative to the saw blade.

In one embodiment, the apparatus comprises: (a) a fence-engaging member for engaging the fence to prevent movement of the apparatus in the transverse direction relative to the fence; (b) a rotary cutting tool for forming the kerf in the workpiece, the rotary cutting tool disposed above the work surface when the fence-engaging member engages the fence; and (c) a guide member for engaging the workpiece to prevent the workpiece from translating in the transverse direction on the work surface relative to the rotary cutting tool, while permitting the workpiece to translate in the longitudinal direction on the work surface relative to the rotary cutting tool, when the fence-engaging member engages the fence.

In one embodiment of the apparatus, the fence-engaging member defines an internal wall of a pocket that fits over and receives the fence.

In one embodiment of the apparatus, the fence-engaging member is detachable from the fence to permit the apparatus to be removed from the table saw.

In one embodiment of the apparatus, the apparatus further comprises at least one motor-actuated feed roller for engaging the workpiece while the roller rotates, to translate the workpiece in the longitudinal direction on the work surface relative to the rotary cutting tool.

In another aspect, the present invention comprises a method for simultaneously forming a kerf in a workpiece along a longitudinal direction and cutting the workpiece to length in a transverse direction perpendicular to the longitudinal direction. The method comprises the steps of: (a) providing a rotary cutting tool for forming the kerf in the workpiece, the rotary cutting tool disposed transversely apart from a saw blade for cutting the workpiece in the longitudinal direction; (b) simultaneously actuating the rotary cutting tool and the saw blade; and (c) moving the workpiece in the longitudinal direction to simultaneously engage the actuated rotary cutting tool and the actuated saw blade.

In one embodiment of the method, the saw blade is part of a table saw comprising a fence, and step (a) comprises attaching a part supporting the rotary cutting tool to the fence.

In one embodiment of the method, step (c) comprises using at least one motor-actuated feed roller for engaging the workpiece while the roller rotates, wherein friction between the roller and the workpiece causes movement of the workpiece.

In another aspect, the present invention comprises an apparatus for forming a kerf in a workpiece supported on a work surface. The apparatus comprises: (a) a rotary cutting tool for forming the kerf in the workpiece, the rotary cutting tool disposed above the work surface; (b) a guide member for engaging the workpiece to prevent the workpiece from translating in the transverse direction on the work surface relative to the rotary cutting tool, while permitting the workpiece to translate in the longitudinal direction on the work surface relative to the rotary cutting tool; and (c) at least one motor-actuated feed roller for engaging the workpiece while the roller rotates, to translate the workpiece in the longitudinal direction on the work surface relative to the rotary cutting tool.

In another aspect, the present invention comprises a method for forming a kerf in a workpiece. The method comprises the steps of: (a) actuating a rotary cutting tool for forming the kerf in the workpiece; and (b) using at least one motor-actuated feed roller for engaging the workpiece while the roller rotates, wherein friction between the roller and the workpiece causes the workpiece to move into engagement with the actuated rotary cutting tool.

In one embodiment of the method, the method further comprises providing a guide member that engages the workpiece to guide movement of the workpiece in a linear path when moved by the roller.

In embodiments of any of the apparatuses and any of the methods described above, the apparatuses and methods may further provide an enclosure that covers the rotary cutting tool to limit access to the rotary cutting tool when the fence-engaging member engages the fence. The enclosure may define a dust collection port through which dust generated by forming the kerf may be suctioned away from the rotary cutting tool.

In embodiments of any of the apparatuses and any of the methods described above, the rotary cutting tool may comprise an abrasive or toothed disc or blade rotatable about a transversely-extending axis, or a cutting bit rotatable about a vertical axis.

### BRIEF DESCRIPTION OF THE DRAWINGS

In the drawings shown in the specification, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 shows a top-front view of an embodiment of an apparatus of the present invention, in use with a table saw.

FIG. 2 shows a top-front view of the apparatus of FIG. 1 when forming a kerf in a plywood sheet, in use with a table saw simultaneously cutting the plywood sheet to length.

FIG. 3 shows a bottom-rear view of a guide member, a rotary cutting tool, and feed rollers of the apparatus of FIG. 1.

FIG. 4 shows a top-rear view of the feed rollers of the apparatus of FIG. 1.

FIG. 5 shows a dust collection port of the apparatus of FIG. 1, coupled to a vacuum line.

### DETAILED DESCRIPTION OF EMBODIMENTS OF THE INVENTION

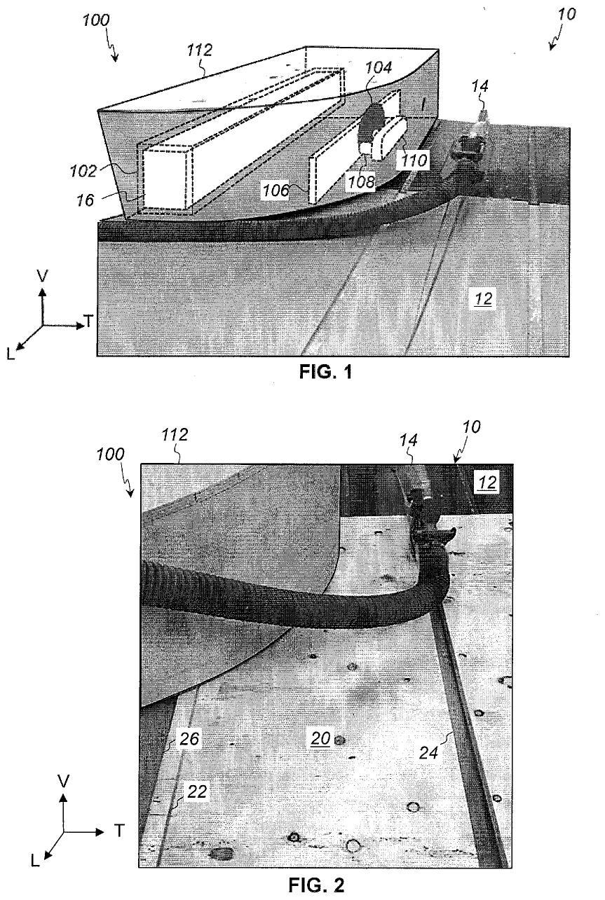

FIG. 1 shows an embodiment of an apparatus (100) of the present invention, in use with saw (10). FIG. 2 shows the apparatus (100) forming a kerf (22) in a workpiece (20) along a longitudinal direction, in use with the table saw (10) simultaneously making a longitudinal cut (24) to cut the workpiece (20) to length in a transverse direction perpendicular to the longitudinal direction. In the Figures, a set of mutually orthogonal axes are provided to indicate the longitudinal direction (L), the transverse direction (T), and the vertical direction (V). In the exemplary use shown in FIG. 2, the workpiece (20) is a plywood sheet, but the apparatus (100) is not limited in use by any particular configuration and material of the workpiece (20).

The saw (10), by itself, may be a conventional table saw and does not form part of the present invention. The table saw (10) includes a work surface (12), a saw blade (14), and a fence (16). The saw blade (14) is for cutting the workpiece (20) in the longitudinal direction, and is actuated by an electric motor or other power source (not shown). In the embodiment shown in FIG. 1, the saw blade (14) is of the rotary type. In conventional use, the fence (16) is used to guide translation of the workpiece (20) in the longitudinal direction along the work surface (12). The fence (16) is moveable in the transverse direction, such as by sliding along a rail or other structure attached to table saw (10), and selectively fixable into a desired transverse position using a clamp or other locking device.

The embodiment of the apparatus (100) shown in FIG. 1 includes a fence-engaging member (102), a rotary cutting tool (104), a guide member (106), and a set of feed rollers (108) actuated by a motor (110). These parts are covered by an enclosure (112), which also forms part of a mounting frame that supports these parts. In FIG. 1, these parts are shown in dashed line as they are hidden from view beneath the optional enclosure (112). The embodiment of the apparatus (100) shown in FIG. 1 may be used as an accessory to the table saw. In other embodiments (not shown), the apparatus (100) is intended for use independently of a table saw (10), and may not have a fence-engaging member (102). In either case, the apparatus (100) may have dimensions and a weight that facilitates its portability.

The fence-engaging member (102) is used for engaging the fence (16) to prevent movement of the apparatus (100) relative to the fence (16) in the transverse direction. In the embodiment shown in FIG. 1, the fence-engaging member (102) is attached to the enclosure (112), and includes a pair of longitudinally extending, internal walls of a pocket that receives the fence (16) in a close-fitting relationship. As such, the apparatus (100) may be conveniently slipped onto the fence (16) to prevent transverse movement of the apparatus (100) relative to the fence (16), without the need for fasteners. Further, the fence-engaging member (102) is detachable from the fence (16) to permit the apparatus (100) to be removed from, and used without the table saw (10). In other embodiments (not shown), the fence-engaging member (102) may be attached to the fence (16) with releasable fasteners such as clamps, screws, or bolts.

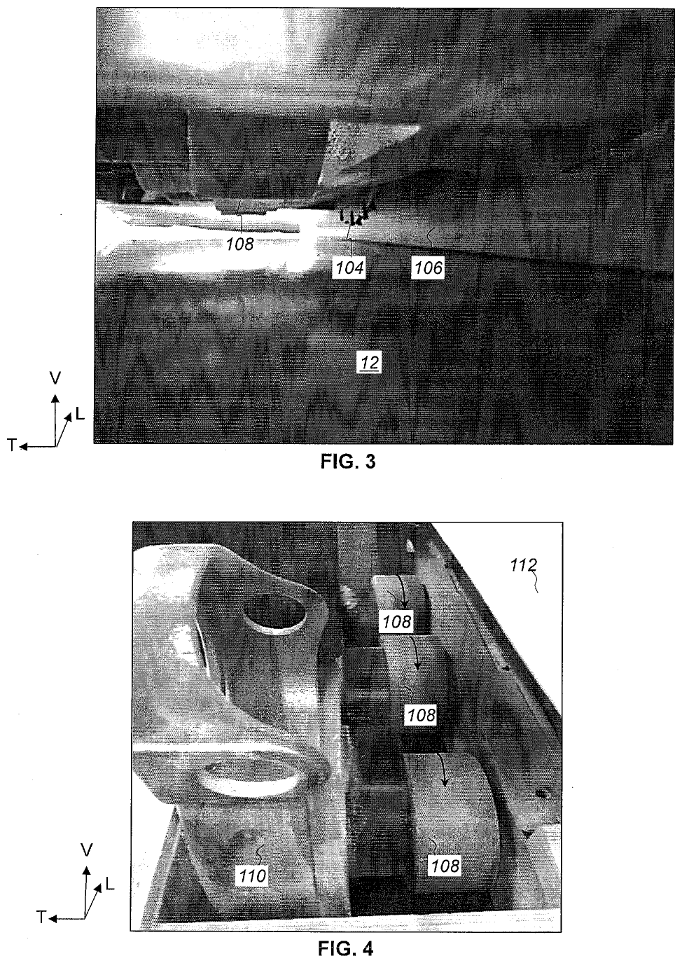

The rotary cutting tool (104) is used for forming the kerf (22) in the workpiece (20), and is actuated by an electric motor or other power source (not shown). “Rotary cutting tool”, as used herein, refers to any tool that, when rotated with sufficient torque relative to the workpiece, acts to remove material from the workpiece. Non-limiting examples of rotary cutting tools include an abrasive or toothed disc or blade that rotates about a transversely-extending axis, or a cutting bit that rotates about a vertical axis (such as a router bit). In the embodiment shown in FIGS. 1 and 3, the rotary cutting tool (104) is a toothed blade that rotates about a transversely-extending axis. As shown in FIG. 3, the rotary cutting tool (104) is disposed above the work surface (12) when the fence-engaging member (102) engages the fence (16). Accordingly, as shown in FIG. 2, as the workpiece (20) translates in the longitudinal direction along the work surface (12) beneath the rotary cutting tool (104), the rotary cutting tool (104) forms the kerf (22) in the upper side of the workpiece (20).

The guide member (106) is used for engaging the workpiece (20) to prevent the workpiece (20) from translating in the transverse direction on the work surface (12) relative to the rotary cutting tool (104), when the fence-engaging member (102) engages the fence (16). However, the guide member (106) permits the workpiece (20) to translate in the longitudinal direction on the work surface (12) relative to the rotary cutting tool (104), when the fence-engaging member (102) engages the fence (16). In the embodiment shown in FIGS. 1 and 3, the guide member (106) is a linear, elongate board, against which a straight edge of the workpiece (20) may be abutted. In other embodiments, the guide member (106) may have a different shape adapted to engage a workpiece (20) with a different shape.

The optional feed rollers (108) actuated by the motor (110) are used to assist the user in advancing the workpiece (20) in the longitudinal direction along the work surface (12). As shown in FIG. 3, the feed rollers (108) are disposed above the work surface (12) when the fence-engaging member (102) engages the fence (16). In the embodiment shown in FIG. 4, a single electrical motor (110) drives the rotation of three feed rollers (108) arranged longitudinally in a row. As shown in FIG. 4, the motor drives rotation of the feed rollers (108) in the direction shown by the curved arrow lines. When the feed rollers (108) engage the upper side of the workpiece (20), friction between the feed rollers (108) and the workpiece (20) causes the workpiece (20) to translate along the work surface (12) in the longitudinal direction. In other embodiments (not shown), the apparatus (100) may have a single feed roller (108) or a different number of feed rollers (108), and the feed rollers (108) may engage a part of the workpiece (20) other than its upper surface.

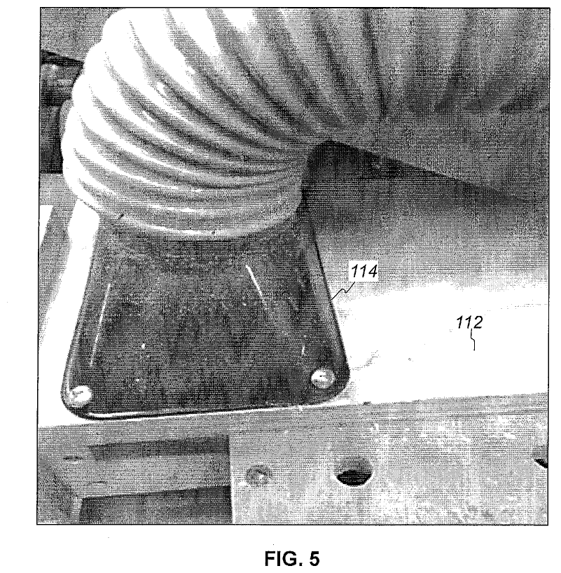

In the embodiment of FIG. 1, the enclosure (112) covers the rotary cutting tool (104) to limit access thereto when the fence-engaging member (102) engages the fence (16). As such, the enclosure (112) may reduce the risk of injury to the user by shielding the rotary cutting tool (104). In the embodiment shown in FIG. 1, the enclosure (112) is in the form of a hollow structure that covers and provides a mounting frame that supports the fence-engaging member (102), the rotary cutting tool (104), the guide member (106), the feed rollers (108) and the motor (110). In the embodiment shown in FIG. 5, the enclosure (112) defines a dust collection port (114) for connection to a vacuum line, which can be used to suction dust generated by the removal of material from the workpiece (20) as the kerf (22) is formed away from the work surface (12) and the rotary cutting tool (104). In the embodiment shown in FIG. 1, the longitudinal leading edge of the enclosure (112) is curved to provide greater visibility of the kerf (22) as it is being formed.

In use and operation of the embodiment of the apparatus (100) of FIG. 1, the user slips the enclosure (112) onto the fence (16) so that the pocket defined by the fence-engaging member (102) receives the fence (16). As a result, the apparatus (100) will move in unison with the fence (16) relative to the saw blade (14). As necessary, the user slides the fence (16) to adjust the transverse position of the guide member (106) so that the saw blade (14) will make a longitudinal cut (24) along the workpiece (20) at a desired transverse distance from the guide member (106) (i.e., the desired cut length of the workpiece (20)). As shown in FIG. 2, the user abuts an edge (26) of the workpiece (20) against the guide member (106). The user activates the power sources for the saw blade (14), the rotary cutting tool (104), and the motor (110). The rotating feed rollers (108) engage the upper side of the workpiece (20) and assist the user with translating the workpiece (20) in the longitudinal direction along the work surface (12), relative to the saw blade (14) and the rotary cutting tool (104). Referring to FIG. 2, as the workpiece (20) advances in the longitudinal direction, the rotary cutting tool (104) forms the kerf (22) in the workpiece (20) by removing material from the workpiece (20), and the saw blade (14) simultaneously makes the longitudinal cut (24) in the workpiece (20). The material removed to form the kerf (22), in the form of dust, is sucked away from the rotary cutting tool (104) and out of the enclosure (112) via the dust collection port (114) (FIG. 5), and into the coupled vacuum line.

Alternatively, the embodiment of the apparatus (100) shown in FIG. 1 may be used without the table saw (10) to form a kerf (22) in the workpiece (20). In this the case, the workpiece (20) may be supported on any suitable work surface. The apparatus (100) may be supported on the ground, the work surface, or any other suitable structure, such that the rotary cutting tool (104) is set at a suitable depth from the upper surface of the workpiece (20) for forming the kerf (108), and the feed rollers (108) are set at a suitable elevation for engaging the upper surface of the workpiece (20).

Interpretation.

Any term or expression not expressly defined herein shall have its commonly accepted definition understood by a person skilled in the art.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation off 5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. An apparatus for forming a kerf in a workpiece along a longitudinal direction, in use with a saw for simultaneously cutting the workpiece to length in a transverse direction perpendicular to the longitudinal direction, a work surface for supporting the workpiece, a saw blade for cutting the workpiece in the longitudinal direction, and a fence having a selectively fixable position in the transverse direction relative to the saw blade, the apparatus comprising:
(a) a fence-engaging member for engaging the fence to prevent movement of the apparatus in the transverse direction relative to the fence;
(b) a rotary cutting tool for forming the kerf in the workpiece, the rotary cutting tool disposed above the work surface when the fence-engaging member engages the fence; and
(c) a guide member for engaging the workpiece to prevent the workpiece from translating in the transverse direction on the work surface relative to the rotary cutting tool, while permitting the workpiece to translate in the longitudinal direction on the work surface relative to the rotary cutting tool, when the fence-engaging member engages the fence.

2. The apparatus of claim 1, wherein the fence-engaging member defines an internal wall of a pocket that fits over and receives the fence.

3. The apparatus of claim 1, wherein the fence-engaging member is detachable from the fence to permit the apparatus to be removed from the table saw.

4. The apparatus of claim 1, wherein the apparatus further comprises at least one motor-actuated feed roller for engaging the workpiece while the roller rotates, to translate the workpiece in the longitudinal direction on the work surface relative to the rotary cutting tool.

5. The apparatus of claim 1, wherein the apparatus further comprises an enclosure that covers the rotary cutting tool to limit access to the rotary cutting tool when the fence-engaging member engages the fence.

6. The apparatus of claim 1, wherein the apparatus further comprises an enclosure that covers the rotary cutting tool and defines a dust collection port for connection to a vacuum line.

7. The apparatus of claim 1, wherein the rotary cutting tool comprises an abrasive or toothed disc or blade rotatable about a transversely-extending axis, or a cutting bit rotatable about a vertical axis.

8. A method for simultaneously forming a kerf in a workpiece along a longitudinal direction and cutting the workpiece to length in a transverse direction perpendicular to the longitudinal direction, the method comprising the step of forming the kerf in the workpiece while simultaneously cutting the workpiece in the longitudinal direction.

9. The method of claim 8, wherein a one motor-actuated feed roller engages the workpiece while the roller rotates, causing movement of the workpiece.

10. The method of claim 8, wherein a kerf cutting rotary tool is enclosed with an enclosure, and the method comprises the further step of suctioning dust generated by forming the kerf through a dust collection port defined by the enclosure.

11. An apparatus for forming a kerf in a workpiece supported on a work surface, the apparatus comprising:
(a) a rotary cutting tool for forming the kerf in the workpiece, the rotary cutting tool disposed above the work surface;
(b) a guide member for engaging the workpiece to prevent the workpiece from translating in the transverse direction on the work surface relative to the rotary cutting tool, while permitting the workpiece to translate in the longitudinal direction on the work surface relative to the rotary cutting tool; and
(c) at least one motor-actuated feed roller for engaging the workpiece while the roller rotates, to translate the workpiece in the longitudinal direction on the work surface relative to the rotary cutting tool.

12. The apparatus of claim 11, wherein the apparatus further comprises an enclosure that covers the rotary cutting tool to limit access to the rotary cutting tool when the fence-engaging member engages the fence.

13. The apparatus of claim 11, wherein the apparatus further comprises an enclosure that covers the rotary cutting tool and defines a dust collection port for connection to a vacuum line.
